(19) United States
(12) Patent Application Publication
(10) Pub. No.: US 2017/0104188 A1
(43) Pub. Date: Apr. 13, 2017

(54) THIN FILM BATTERY HAVING LOW FLUID CONTENT AND AN INCREASED SERVICE LIFE

(71) Applicant: SCHOTT AG, Mainz (DE)

(72) Inventors: Miriam KUNZE, Saulheim (DE); Ulrich PEUCHERT, Bodenheim (DE)

(73) Assignee: SCHOTT AG, Mainz (DE)

(21) Appl. No.: 15/386,060

(22) Filed: Dec. 21, 2016

Related U.S. Application Data
(63) Continuation of application No. PCT/EP2015/064069, filed on Jun. 23, 2015.

(30) Foreign Application Priority Data
Jun. 23, 2014 (DE) 102014008934.7
Jul. 23, 2014 (DE) 102014010735.3
Mar. 16, 2015 (DE) 102015103857.9
Mar. 16, 2015 (DE) 102015103863.3

(51) Int. Cl. H01M 2/02; H01M 10/0585; H01M 10/04; H01M 2/08; H01M 10/42; C03C 3/089; C03C 3/091; C03C 3/093; C03C 3/064; C03C 3/066; C03C 3/11; C03C 3/078; C03C 3/095; C03C 3/097; C03C 3/087; C03C 3/083; C03C 3/085; C03C 8/02; C03C 8/04; H01M 10/0525

(52) U.S. Cl. CPC H01M 2/0267; H01M 10/0525; H01M 10/0585; H01M 10/0436; H01M 2/08; H01M 10/4235; H01M 2/0207; C03C 3/089; C03C 3/091; C03C 3/093; C03C 3/064; C03C 3/066; C03C 3/11; C03C 3/078; C03C 3/095; C03C 3/097; C03C 3/087; C03C 3/083; C03C 3/085; C03C 8/02; C03C 8/04; H01M 2220/30

(57) ABSTRACT

A thin film battery is provided that has an increased service life and low fluid content. The fluid content is at most 2000 ppm, preferably at most 500 ppm, particularly preferably at most 200 ppm, and most preferably at most 50 ppm. An inorganic, silicon-containing, in particular silicate, substantially fluid-free material for thin film batteries are provided, as well as methods for producing such thin film batteries.

### CROSS REFERENCE TO RELATED APPLICATIONS

This application is a continuation of International Application No. PCT/EP2015/064069 filed on Jun. 23, 2015, which claims the benefit under 35 U.S.C. 119 of German Application No. 102014008934.7 filed on Jun. 23, 2014, German Application No. 102014010735.3 filed on Jul. 23, 2014, German Application No. 102015103857.9 filed on Mar. 16, 2015, and German Application No. 102015103863.3 filed on Mar. 16, 2015, the entire contents of each of which is incorporated by reference herein.

### BACKGROUND

1. Field of the Invention

The invention relates to thin film batteries, in particular lithium-based thin film batteries which have a low fluid content and resulting therefrom an extended service life.

2. Related Art

Microelectronic components, in particular miniaturized storage elements for electrical energy are becoming increasingly important, for example for so-called smart cards.

In this respect, in particular lithium-based thin film batteries have a number of particularly preferred properties, for example low weight and high power density. However, there are still significant difficulties with respect to their service life, cycle stability, i.e. the number of charging and discharging cycles they can be subjected to, and generally with regard to their service life. The reason for this is found in the fact that lithium in its elemental form as it can be found in the anodes of charged lithium-based batteries or accumulators, for example, has an extremely low reduction potential. Other materials of the active battery materials of a lithium-based battery or a lithium-based accumulator are also extremely susceptible to degradation reactions. Therefore, a lithium-based storage unit for electrical energy usually does not use elemental or metallic lithium as an anode material, but a material enhanced in terms of durability, for example graphite into which lithium can be intercalated as an elemental material, i.e. with oxidation stage 0. However, this material also exhibits high reactivity. Other lithium-based battery materials moreover exhibit high hygroscopy, i.e. they attract water.

Due to the various links lithium is capable of forming, undesirable compounds might be formed very easily when lithium-containing material gets in contact with fluids, which material will then no longer be available for cyclically storing and delivering electrical energy, so that the storage capacity of the lithium-based battery or the lithium-based accumulator is correspondingly reduced. This may be lithium carbonate, Li₂CO₃, lithium hydroxide, LiOH, for example, or other poorly soluble compounds, in which the lithium ions or atoms are strongly bound and thus are no longer available for charge transport. Furthermore, most of these lithium compounds moreover have the property of binding fluids, for example H₂O, CO₂, N₂, so that the adverse reactions with fluids do not only reduce the storage capacity of the accumulator or the battery, but furthermore bind other fluids which in turn also cause reactions with further lithium, so that overall a kind of self-reinforcing process is initiated.

The issue of reducing or possibly even completely avoiding such undesirable reactions is one of the key problems for the manufacturing of improved lithium-based storage elements for electrical energy, so that various solution approaches have been discussed in literature.

For example, US 2004/0018424 A1 describes a rechargeable lithium-based thin film cell comprising a polyimide substrate. The polyimide substrate is specifically dried, for which purpose the polyimide is first placed in acetone, thereby replacing at least a portion of the water bound in the polyimide or adsorbed to the polyimide. This is followed by a thermal drying process. Furthermore, the thin film cell additionally has a parylene topcoat which functions as a permeation barrier and is intended to protect the cell materials from degradation. However, the so obtained substrate material is not yet completely freed from water, rather a reduction in the water content is achieved. Furthermore, polymeric encapsulation materials mostly have only an inadequate barrier effect against fluids, in particular for particularly sensitive applications.

US 2004/0029311 A1 describes an encapsulated electrochemical storage unit in which a multilayered laminate is pressed onto the functional layers of the electrochemical storage unit. The multilayered laminate may include a metallic layer. Furthermore, the layer which is in contact with the underlying layers of the storage cell consists of an adhesive material so as to ensure permanent contact between the laminate and the substructure. However, such laminates are usually susceptible to delamination, that is a detachment of the layers. In addition there is a risk that the organic adhesive material itself may corrode the functional materials of the cell.

US 2006/0216589 A1 furthermore describes a thin film battery in which different functional layers are applied on a substrate. Furthermore, the thin film battery comprises a cap which is applied spaced apart from the surface of the functional layers so that a gap is created between the surface of the cap and that of the functional layer. Furthermore, the battery is protected against environmental influences by an organic polymer-based sealing or encapsulation between the substrate and the cap. The gap serves to compensate for thickness variations or thermal expansion of the functional layers of the battery, which might be caused in the respective charging and discharging cycles of the battery. A drawback hereof is that such a gap is naturally filled with a fluid and so reactions may take place between the fluids and the battery materials. Moreover, polymeric encapsulation materials usually have a permeation rate for fluids, such as water, of about 1 g/m²·d. Although this is sufficient for most applications of such sealing polymers, the limits of performance are however encountered in applications in the high-performance range, that is for example in miniaturized electronic components such as, e.g., a thin film-based lithium-ion battery or a lithium-ion accumulator.

Furthermore, US 2008/0003492 A1 describes a hermetic encapsulation for a lithium-ion battery which may comprise an encapsulation applied between the substrate and the superstrate covering the layers applied on the substrate, i.e. comparable to a seal, or can be in the form of a multilayered laminate with barrier properties. Here, again, the difficulties already discussed above arise, i.e. an excessive permeation rate of organic sealing materials on the one hand, and on the other the risk of delamination of multilayered material in contact with functional materials on the other.

US 2008/0213664 A1 describes a method for manufacturing a battery in which a substrate material is annealed, with the intension to reduce not only surface contaminants but also water that is chemically bound in the substrate, for example crystallization water. Annealing of the substrate material may be performed before coating it with a first layer and/or during thermal annealing of functional layers of the battery, for example of lithium-cobalt oxide in the case of a lithium-ion battery. The annealing for removing water bound in the substrate, such as crystallization water, usually requires temperatures of several hundred ° C. In the case of mica, for example, crystallization water is usually released at temperatures above 500° C. In fact it is possible in this way to significantly reduce the fluid content in a mica-based battery, for example, however, it is particularly in the case of layered silicates which have cavities within their crystalline structures or may embed ions or absorbents between the individual crystal-forming layers that complete absence of fluids cannot be achieved. This is all the more true since the crystallization water is a constituent element of mica and complete removal thereof would cause disintegration of the crystal structure and thus a loss in mechanical stability of the substrate.

US 2008/0263855 A1 and US 2009/0057136 A1 each also disclose methods for producing batteries on a substrate which is annealed for reducing fluids, in particular water, the annealing essentially corresponding to the method described in US 2008/0213664 A1.

US 2009/0214899 A1 describes a metallic seal for protecting the functional layers of a thin film battery, the seal being in the form of a layer and covering at least portions of the functional layers, in particular also the edges thereof. In addition to a first seal, there are generally a plurality of further seals which protect the remaining functional layers not yet covered by the first sealing layer. These further seals also consist of metal and can moreover be contacted electrically.

US 2010/0190051 A1 describes a barrier layer for a thin film battery which may consist of tin compounds, for example tin oxide, tin phosphate, or tin fluorophosphate, and of glass, for example chalcogenide glass, tellurite glass, or borate glass. The layer encapsulates the layers of the thin film battery and hinders or even completely prevents the layers from being exposed to air or moisture. Although it is quite possible that these layers have a good barrier effect, in particular the glass materials are however extremely sensitive to environmental influences. For example the chalcogenide glasses are not stable in air and decompose. Thus, the layer materials are not suitable for use in batteries which are to be stored under normal environmental conditions.

U.S. Pat. No. 5,338,625 describes a glass as a substrate for a thin film battery based on lithium. However, no statement is made about its water content or its permeation effect.

U.S. Pat. No. 6,214,061 B1 describes a protection for a lithium electrode, consisting of a protective layer which can be amorphous or glassy, but at the same time shall conduct ions of the active battery material, i.e. lithium in this case, the layer being in all cases produced by a coating process and being thinner than 5 μm. The lithium-metal system with superimposed protective layer is referred to as an encapsulated electrode and has the consequence that the lithium electrode does not immediately degrade when getting in contact with fluids, for example nitrogen. However, there will usually be no adequate barrier effect of the protective layer under normal atmospheric conditions, since glasses that conduct lithium ions and have a conductivity which is adequate for technical applications are themselves generally very sensitive to degradation reactions, for example, with water or oxygen.

U.S. Pat. No. 6,387,563 B1 describes a protective layer for a thin film battery, the protective layer consisting of an epoxy-based system and a glass layer. The epoxy layer functions as an adhesive layer for the subsequently applied glass layer which generally consists of a thin glass sheet. The epoxy layer can be cured through the glass layer. By using the initially plastic epoxy resin it is possible to largely avoid a formation of ‘gas pockets’ in the battery and therefore reactions thereof with the battery materials. However, a drawback hereof is that, again, there is direct contact with initially liquid material, which may also lead to degradation of the battery materials, although to a lesser extent than with the more reactive fluids such as, e.g., O₂ or H₂O.

A very similar embodiment of an encapsulated battery is described in US 2013/0098532 A1. Additionally, annealing of the substrate may be performed here. The encapsulation consists of an organic compound to which a ‘cap’ or a superstrate is applied. Either a gap may remain in the battery, or the organic encapsulation material may be applied so as to completely surround the layer structure of the thin film battery.

US 2013/0260230 A1 describes a method for producing a battery on a substrate. Here, again, it is described that the substrate can be annealed. Furthermore, an encapsulation is applied around the battery structures, a superstrate is bound to the overall structure using an organic encapsulation medium and closes the overall structure.

Furthermore, WO 2014/062676 A1 describes the use of a glass substrate which has a thermal expansion coefficient from 7 to 10 ppm/K. There are no statements made about the fluid content of this glass substrate nor about its permeation properties. Rather, the document describes different layers for sealing the battery, in particular metallic protective layers which are superimposed on the layer structure.

US 2012/040211 A describes a glass film which can serve as a substrate for a lithium-ion battery. This glass film has a water permeation rate of less than 1 g/m²·d and an oxygen permeation rate of less than 1 cc/m²·d. However, such a value is still extremely high and is rather in the order of magnitude of conventional encapsulation polymers. Furthermore, no statement is made about the fluid content of the glass film.

Hence, the prior art shows a multiplicity of different ways of avoiding degradation of a thin film battery or thin film accumulator, especially for a lithium-based thin film battery or accumulator. All of the approaches mentioned above have certain advantages but on the other hand accept significant drawbacks such as complex additional process steps in the form of heat treatments or insufficient barrier effects due to the use of polymers for encapsulation or the risk of delamination of barrier coatings. Therefore, there is a need for a material which can be used easily for the manufacturing of thin film batteries, in particular lithium-based thin film batteries, that have an increased service life.

### SUMMARY

An object of the invention is to provide a thin film battery having an increased service life and a low content of fluids, in particular of fluids which have a corrosive and/or degrading effect. Another aspect of the invention relates to the provision of a substrate material having a low fluid content, and to a method for producing a thin film battery that has a low fluid content and increased service life.

In the context of the present invention, the terms ‘battery’ and ‘rechargeable battery’ and ‘accumulator’ are used synonymously. Thus, the thin film battery of the present invention is a rechargeable battery.

The thin film battery of the present invention is in particular a lithium-based thin film battery. Such thin film batteries usually comprise a substrate on which different functional layers are applied in a particular sequence, for example cathode and anode collectors, a cathode layer, an electrolyte, and optionally an anode, and additionally further layers, for example for encapsulating the battery for protection from degradation by environmental influences. Such a battery structure is exemplified in US 2004/0018424 A1, the exact design of the battery may differ depending on the type and manufacturer.

The thin film battery, in particular the lithium-based thin film battery of the present invention has a long service life. The service life of such a battery can be specified in different ways.

For a rechargeable thin film battery, for example, a parameter known as cycle stability is of particular importance. Cycle stability herein refers to the number of charging and discharging operations that are possible for a battery without causing battery failure when used as intended, i.e. when so-called deep discharges or the like are avoided. Battery failure means that energy can no longer be fed into or drawn from the battery or that the storage capacity of the battery has fallen to less than 80% of the original storage capacity. Each cycle comprises one charging process and one discharging process.

Also, the possibility of storing the battery under environmental conditions or ‘normal atmosphere’, i.e. under non-controlled temperature and humidity, is of importance. Due to their small spatial dimensions, thin film batteries may even be used in subcutaneous applications.

In addition to storage and cycle stability of a thin film battery, continuous operation durability is also important. This is the time for which energy can actually actively be extracted from or supplied into a battery.

The thin film battery of the present invention has an increased service life in a manner so that at least one of the following features is satisfied:
it exhibits a cycle stability of at least 5,000 cycles, preferably at least 10,000 cycles, and more preferably at least 15,000 cycles;
in normal environment, i.e. not controlled, in particular not controlled with respect to temperature and/or atmospheric humidity, it can be stored for at least 1 year, preferably at least 2 years, and more preferably at least 5 years; or
it exhibits a continuous operation durability of at least 5,000 hours, preferably at least 10,000 hours.

Furthermore, the thin film battery of the present invention has a low fluid content. In the context of the present invention, fluid refers to liquid and/or gaseous substances and also to their chemical or physical adsorbates and/or their derivatives. In the present invention, derivative refers to a compound of a fluid which is present in solid form but can easily be re-converted into a fluid form, for example by heat supply and the resulting decomposition of the derivative.

By way of example, fluid refers to water in liquid form or as water vapor, but also when present as chemically or physically bound surface water in the form of an adsorbate or for instance when occurring as crystallization water in solid form in a structure, as a derivative in the sense of the present invention. Similarly, CO₂ may be present in gaseous or adsorbed form, in particular adsorbed to LiOH, or else in the form of a carbonate.

The total fluid content of the thin film battery according to the present invention is 2000 ppm or less, preferably 500 ppm or less, and more preferably 200 ppm or less, and most preferably 50 ppm or less, based on the weight of the thin film battery. In the context of the present invention, an article, for example a thin film battery, or a material having such a low fluid content will also be referred to as substantially fluid-free.

In addition, the thin film battery of the present invention comprises at least one element which is made of an inorganic, silicon-containing, in particular silicate, substantially fluid-free material.

According to one embodiment of the invention, the fluids comprise H₂O, O₂, N₂, CO₂, and/or hydrogen halides and/or their chemical and/or physical adsorbates and/or derivatives.

According to a further embodiment of the invention, the inorganic, silicon-containing, in particular silicate, substantially fluid-free material has a fluid content, in particular an H₂O content, of less than 2 wt %, preferably less than 0.5 wt %, more preferably less than 0.2 wt %, and most preferably less than 0.05 wt %, wherein fluid substances which are bound within the chemical structure of the material, for example in the form of crystallization water or hydrates or OH groups also count for the fluid content.

The fluid content of the inorganic, silicon-containing, in particular silicate, substantially fluid-free material is determined by thermal analysis, for example by differential thermoanalysis, or by thermogravimetry, or by differential scanning calorimetry.

In a further embodiment of the invention, the thin film battery furthermore comprises at least one encapsulation, which encapsulation at least partially seals at least one boundary surface of at least one functional layer of the thin film battery. In this context, functional layer of the battery refers to a layer which is actively involved in the electrical energy charging and discharging operations in the battery, for example as a cathode, as an anode, or in the form of an electron or ion conducting function.

Preferably, the at least one encapsulation is at least partially provided in the form of the inorganic, silicon-containing, in particular silicate, substantially fluid-free material.

However, the encapsulation may as well at least partially be provided in the form of an organic and/or semi-organic material, for example as a hybrid material including an SiO2 gel with functional organic groups.

The inorganic, silicon-containing, in particular silicate, substantially fluid-free material of the present invention exhibits a permeation rate for fluid of <10⁻³ g/(m²·d), preferably of <10⁻⁵ g/(m²·d), and more preferably of <10⁻⁶ g/(m²·d).

In a further embodiment of the invention, the inorganic, silicon-containing, in particular silicate, substantially fluid-free material of the present invention furthermore has a specific electrical resistance at a temperature of 350° C. and at an alternating current with a frequency of 50 Hz of greater than 1.0*10⁶ Ohm·cm.

The inorganic, silicon-containing, in particular silicate, substantially fluid-free material of the present invention is preferably distinguished by a maximum load temperature θ_{Max} of at least 300° C., preferably at least 400° C., more preferably at least 500° C., and most preferably at least 600° C. The maximum load temperature is the temperature at which the functional integrity of the material is still fully ensured, for example in the form of its mechanical stability, or at which significant transformation reactions have not yet occurred. The maximum load temperature of a compound may be the temperature at which significant decomposition of the material occurs, for example by disintegration into several, even gaseous components, or its melting or softening temperature. If the material is a glassy material, usually T_{g} will be considered as the maximum load temperature. T_{g} which is known as transformation or glass transition temperature is defined by the point of intersection of the tangents to the two branches of the expansion curve during a measurement with a heating rate of 5 K/min. This corresponds to a measurement according to ISO 7884-8 or DIN 52324, respectively.

In a further embodiment of the invention, the inorganic, silicon-containing, in particular silicate, substantially fluid-free material of the present invention has a coefficient of linear thermal expansion α in a range from 2.0*10⁻⁶/K to 10*10⁻⁶/K, preferably from 2.5*10⁻⁶/K to 9.5*10⁻⁶/K, and more preferably from 3.0*10⁻⁶/K to 9.5*10⁻⁶/K. Here, the linear coefficient of thermal expansion α in the range from 20 to 300° C. is meant, unless otherwise stated. The notations α and α₂₀₋₃₀₀ are used synonymously within the context of the present invention. The given value is the nominal coefficient of mean linear thermal expansion according to ISO 7991, which is determined in static measurement.

The inorganic, silicon-containing, in particular silicate, substantially fluid-free material of the present invention preferably includes network formers and separation site formers, wherein the molar ratio of separation site formers to network formers is less than or equal to 0.25, preferably less than or equal to 0.2, and more preferably between 0.015 and 0.16. The term ‘network formers’ refers to elements which together with oxygen form coordination polyhedra, and these coordination polyhedra may link together to form large, possibly even infinite macromolecules. ‘Separation site formers’, by contrast, refers to elements which interrupt the links between the individual coordination polyhedra thereby causing a reduction in the degree of polymerization. Alkali metals and/or alkaline earth metals, for example, function as separation site formers, and aluminum and/or boron and/or silicon may be taken into consideration as network formers.

The inorganic, silicon-containing, in particular silicate, substantially fluid-free material of the present invention preferably has a structure comprising a network of vertex-linked structural components formed of the oxygen coordination polyhedra of network forming elements, in particular a network of vertex-linked tetrahedra of the general formula [XO₄], wherein X comprises at least silicon and/or aluminum.

It is especially the multiplicity of linking possibilities of the coordination polyhedra which causes relatively large cavities to be formed in the structure of the solid body, which cavities are suitable for incorporating for instance fluids. In the crystalline structure of mica or layered silicates, for example, there are usually layers in which the coordination polyhedra are arranged in the form of hexagonal rings, in the present case tetrahedrally oxygen coordinated silicon, in the center of which fluids can be incorporated. Moreover, further compounds can be incorporated between the layers of the layered silicates. This high absorption capacity of layered silicates is also known as swelling ability and is often exploited technically, for example by intentionally linking organic groups, but is a drawback when freedom of fluids is required.

But also other, more dense silicon-containing materials, in particular silicate materials, exhibit preferred orientations in their structure, for example silicates having a garnet structure, which may be reflected macroscopically, for example as cleavability, but also as a preferred permeability for certain materials. For example, for garnet structures it is known that they have channels, through which for instance ions can migrate, in the case of a suitable chemical composition. This is exploited in the case of the so-called LLZO materials which are materials composed of lithium, lanthanum, zirconium, and oxygen (wherein some of the zirconium may as well be replaced by niobium or tantalum or similar elements), and which exhibit particularly high lithium ion conductivity.

In order to avoid such preferred orientations with the associated risk of permeability and/or storage capacity for fluids, is isotropic according to a preferred embodiment of the invention. A material is called isotropic if its properties are the same in all spatial directions.

In a preferred embodiment, the inorganic, silicon-containing, in particular silicate, substantially fluid-free material according to the invention is amorphous.

Preferably, it is a glass.

According to a further embodiment of the invention, the inorganic, silicon-containing, in particular silicate, substantially fluid-free material may be provided as a substrate and/or as a superstrate in the thin film battery of the invention.

Here, the support for the subsequent structures which form the actual thin film battery is called a ‘substrate’, and a cover which is for instance applied to the finished coatings of the thin film battery is called a ‘superstrate’.

In the context of the present invention, the inorganic, silicon-containing, in particular silicate, substantially fluid-free material is considered a superstrate if it is not used as a substrate, that is to say as a support for applying further refinements or structures, but is rather employed as a superimposed element, for example a sealing or cover glass. Prior to its use as a superstrate, for example as a cover glass, however, the superstrate itself may also have been subjected to separate processes during which it assumed the function of a substrate for these separate processes and may for instance carry structures or patterns such as optical coatings for selectively adjusting optical transmission.

In the context of the present invention, the superstrate may be made of the same material as the substrate, i.e. may have an identical chemical composition. This is advantageous, for example, if the substrate and the superstrate should have the same coefficient of thermal expansion if possible, in order to avoid thermal stresses.

However, it is also possible that the substrate and the superstrate are intentionally made of different materials. If, for example, the superstrate is only used as a diffusion barrier against the passage of fluids, i.e. if optical or chemical properties are of secondary importance, a rather inexpensive material may be used, for example a glass of higher thickness, with the composition of a soda-lime glass, and without special coatings such as optical coatings.

In order to ensure an appropriate diffusion barrier against the passage of fluids, an encapsulation is furthermore required between the substrate and the superstrate. Such a lateral barrier may for example be provided by suitable polymers. Furthermore, it is as well possible to provide such a barrier by employing glass solders, in particular if a particularly high diffusion barrier is necessary or desirable. Moreover, it is also possible to selectively adjust such glass solders with regard to their thermal expansion. If, for example, the expansion coefficients of the substrate and the superstrate are different, a thermal expansion coefficient of the glass solder can be selected in a manner so that it has a mean value. Furthermore, the thermal expansion coefficient of the glass solder will generally be adjusted to the active components of the relevant storage element.

Preferably, both the substrate and the superstrate are made of the same inorganic, silicon-containing, in particular silicate, substantially fluid-free material.

If the inorganic silicon-containing, in particular silicate material of the present invention is used as a substrate and/or as a superstrate in the thin film battery of the invention, it is obtained, according to one embodiment of the invention, by a melting process with subsequent shaping, wherein the material is preferably provided in the form of a glass ribbon or glass sheet, and wherein shaping is performed inline in a hot forming process such as a float process, an overflow fusion process, or a down-draw process, or offline in a redrawing process, by separately heating a previously cooled glassy shaped body.

However, it is also possible that the inorganic, silicon-containing, in particular silicate, substantially fluid-free material of the thin film battery according to the invention is provided in the form of a layer, alternatively or additionally.

According to a preferred embodiment of the invention, the material, if provided in the form of a layer, is obtained by a vapor deposition process, preferably by an electron beam evaporation process.

According to another embodiment of the invention, the thin film battery according to the invention further comprises at least one fluid getter. In the present context, getter refers to a material which is capable of binding fluid.

This getter is preferably provided as a reaction and/or sacrificial material which forms insoluble or only very poorly soluble compounds with fluids.

In a further embodiment of the invention, this getter comprises a metal, for example a base metal, preferably an alkali metal or alkaline earth metal or a mixture or alloy of metals, for example of alkali metals and/or alkaline earth metals, and/or an adsorbent. In the present context, adsorbent refers to a material which is capable of binding fluids by adsorption.

Actually, fluid getters are basically not new for electrochemical energy storage systems. For example, international patent application WO 2014/016039 A1 describes a compound V1 which is capable of forming, together with a fluorine-containing compound V2, a non-volatile, non-gaseous, and fluorine-binding compound V3.

Also, U.S. patent application US 2012/0050942 A1 describes a material which is capable of binding HF or hydrogen.

Both of these documents have in common that they relate to lithium-based systems which include a liquid electrolyte, that is an electrolyte consisting of a solvent and a conductive salt. If now water or hydrogen enters the energy storage, hydrogen fluoride HF will be formed, which may cause bloating of the battery, for example, in the worst case until mechanical failure of the battery casing with an associated escape of hazardous substances. Moreover, insoluble lithium compounds might be formed, e.g. LiF, so that the system is deprived of the element essential for the storage of electrical energy.

In contrast to these HF and/or hydrogen getters, the getter materials of the present invention are adapted so as to adsorb other fluids, in addition to water for example also oxygen and/or nitrogen. Moreover, the mechanisms of action relevant for the above-described getter materials cannot have any effect in a pure solid state battery constituting a subject matter of the present invention. Rather, important components which are necessary for the reactions described in the prior art to take place are missing here. In particular fluorine is not present in such a solid state battery, so that HF gettering is not considered.

According to a preferred embodiment of the invention, the inorganic, silicon-containing, in particular silicate, substantially fluid-free material of the present invention has a thickness of less than 2 mm, preferably less than 1 mm, more preferably less than 500 μm, yet more preferably less than or equal to 200 μm, and most preferably of not more than 100 μm.

In a particularly preferred embodiment of the invention, the inorganic, silicon-containing, in particular silicate, substantially fluid-free material includes a certain amount of lithium. This is of particular advantage if the thin film battery of the invention is a lithium-based thin film battery. If one of the measures for achieving a fluid-free nature of the material is performed, i.e. for example heat treatment, also referred to as annealing, and if this is only performed after functional layers have been applied, for example during annealing of a functional layer so that the latter has an increased performance in terms of storage capacity for electrical energy, for example, such a lithium content will be particularly advantageous.

In this case, the Li₂O content is 7 wt % or less, preferably 5.2 wt % or less, and more preferably 2.5 wt % or less, yet more preferably 0.5 wt % or less, and most preferably 0.2 wt % or less, the content of Li₂O being at least 0.1 wt %.

The thin film battery according to the invention may be produced by a method which comprises at least the steps of: providing a substrate with a fluid content, in particular an H₂O content, of less than 2 wt %, preferably less than 0.5 wt %, and more preferably less than 0.2 wt %, and most preferably less than 0.05 wt %, wherein fluid substances which are bound within the chemical structure of the material, for example in the form of crystallization water or hydrates or OH groups, also count for the fluid content; applying the functional layers of the thin film battery; and applying at least one encapsulation for the functional layers of the thin film battery, wherein the encapsulation at least partially seals at least one boundary surface of at least one functional layer of the thin film battery.

In a further embodiment of the invention, the substrate and/or at least one encapsulation of the thin film battery is at least partially made of an inorganic, silicon-containing, in particular silicate, substantially fluid-free material.

In a preferred embodiment of the invention, the inorganic, silicon-containing, in particular silicate, substantially fluid-free material is a substrate in the form of a sheet-like shaped body, which substrate is subjected to a heat treatment, also referred to as annealing, during or after shaping, for achieving its fluid-free nature, in particular to a heat treatment below 500° C., and/or to flaming, wherein the heat treatment is preferably performed during thermal post treatment of at least one of the functional layers of the thin film battery.

In a further embodiment of the invention, a getter material for fluids is applied to the substrate, for example a getter material in the form of a metal, preferably a base metal, for example an alkali or alkaline earth metal and/or mixtures and alloys of metals, or a getter material in the form of an adsorbent.

In a further embodiment of the invention, the getter material is applied before performing the fluid-reducing process, i.e. for instance prior to the heat treatment, and the getter material is removed after the fluid-reducing process has been performed.

The following tables give some exemplary compositions of inorganic, silicon-containing, in particular silicate, substantially fluid-free materials.

### EXAMPLARY EMBODIMENT 1

A composition of an inorganic, silicon-containing, in particular silicate, substantially fluid-free material is given, by way of example, by the following composition, in wt %:

| | |
|---|---|
| SiO₂ | 30 to 85 |
| B₂O₃ | 3 to 20 |
| Al₂O₃ | 0 to 15 |
| Na₂O | 3 to 15 |
| K₂O | 3 to 15 |
| ZnO | 0 to 12 |
| TiO₂ | 0.5 to 10 |
| CaO | 0 to 0.1. |

### EXAMPLARY EMBODIMENT 2

A further composition of an inorganic, silicon-containing, in particular silicate, substantially fluid-free material is furthermore given, by way of example, by the following composition, in wt %:

| | |
|---|---|
| SiO₂ | 58 to 65 |
| B₂O₃ | 6 to 10.5 |
| Al₂O₃ | 14 to 25 |
| MgO | 0 to 3 |
| CaO | 0 to 9 |
| BaO | 0 to 8, preferably 3-8 |
| ZnO | 0 to 2, |

wherein a total of the amounts of MgO, CaO, and BaO is in a range from 8 to 18 wt %.

### EXAMPLARY EMBODIMENT 3

Yet another composition of an inorganic, silicon-containing, in particular silicate, substantially fluid-free material is furthermore given, by way of example, by the following composition, in wt %:

| | |
|---|---|
| SiO₂ | 55 to 75 |
| Na₂O | 0 to 15 |
| K₂O | 0 to 14, preferably 2 to 14 |
| Al₂O₃ | 0 to 15 |
| MgO | 0 to 4 |
| CaO | 3 to 12 |
| BaO | 0 to 15 |
| ZnO | 0 to 5 |
| TiO₂ | 0 to 2. |

### EXAMPLARY EMBODIMENT 4

Yet another composition of an inorganic, silicon-containing, in particular silicate, substantially fluid-free material is furthermore given, by way of example, by the following composition, in wt %:

| | |
|---|---|
| SiO₂ | 61 |
| B₂O₃ | 10 |
| Al₂O₃ | 18 |
| MgO | 2.8 |
| CaO | 4.8 |
| BaO | 3.3. |

With this composition, the following properties are obtained:

| | |
|---|---|
| α₍₂₀₋₃₀₀₎ | 3.2 · 10⁻⁶/K; |
| T_{g} | 717° C.; and |
| Density | 2.43 g/cm³. |

### EXEMPLARY EMBODIMENT 5

Yet another composition of an inorganic, silicon-containing, in particular silicate, substantially fluid-free material is furthermore given, by way of example, by the following composition, in wt %:

| | |
|---|---|
| SiO₂ | 64.0 |
| B₂O₃ | 8.3 |
| Al₂O₃ | 4.0 |
| Na₂O | 6.5 |
| K₂O | 7.0 |
| ZnO | 5.5 |
| TiO₂ | 4.0 |
| Sb₂O₃ | 0.6 |
| Cl⁻ | 0.1. |

With this composition, the following properties are obtained:

| | |
|---|---|
| α₍₂₀₋₃₀₀₎ | 7.2 · 10⁻⁶/K; |
| T_{g} | 557° C.; and |
| Density | 2.5 g/cm³. |

### EXEMPLARY EMBODIMENT 6

Another sheet-like discrete element is given, by way of example, by the following composition, in wt %:

| | |
|---|---|
| SiO₂ | 69 +/− 5 |
| Na₂O | 8 +/− 2 |
| K₂O | 8 +/− 2 |
| CaO | 7 +/− 2 |
| BaO | 2 +/− 2 |
| ZnO | 4 +/− 2 |
| TiO₂ | 1 +/− 1. |

With this composition, the following properties are obtained:

| | |
|---|---|
| α₍₂₀₋₃₀₀₎ | 9.4 · 10⁻⁶/K; |
| T_{g} | 533° C.; and |
| Density | 2.55 g/cm³. |

### EXEMPLARY EMBODIMENT 7

Yet another composition of an inorganic, silicon-containing, in particular silicate, substantially fluid-free material is furthermore given, by way of example, by the following composition, in wt %:

| | |
|---|---|
| SiO₂ | 80 +/− 5 |
| B₂O₃ | 13 +/− 5 |
| Al₂O₃ | 2.5 +/− 2 |
| Na₂O | 3.5 +/− 2 |
| K₂O | 1 +/− 1. |

With this composition, the following properties are obtained:

| | |
|---|---|
| α₍₂₀₋₃₀₀₎ | 3.25 · 10⁻⁶/K; |
| T_{g} | 525° C.; and |
| Density | 2.2 g/cm³. |

### EXEMPLARY EMBODIMENT 8

Yet another composition of an inorganic, silicon-containing, in particular silicate, substantially fluid-free material is furthermore given, by way of example, by the following composition, in wt %:

| | |
|---|---|
| SiO₂ | 62.3 |
| Al₂O₃ | 16.7 |
| Na₂O | 11.8 |
| K₂O | 3.8 |
| MgO | 3.7 |
| ZrO₂ | 0.1 |
| CeO₂ | 0.1 |
| TiO₂ | 0.8 |
| As₂O₃ | 0.7. |

With this composition, the following properties are obtained:

| | |
|---|---|
| α₍₂₀₋₃₀₀₎ | 8.6 · 10⁻⁶/K; |
| T_{g} | 607° C.; and |
| Density | 2.4 g/cm³. |

### EXEMPLARY EMBODIMENT 9

Yet another composition of an inorganic, silicon-containing, in particular silicate, substantially fluid-free material is furthermore given, by way of example, by the following composition, in wt %:

| | |
|---|---|
| SiO₂ | 62.2 |
| Al₂O₃ | 18.1 |
| B₂O₃ | 0.2 |
| P₂O₅ | 0.1 |
| Li₂O | 5.2 |
| Na₂O | 9.7 |
| K₂O | 0.1 |
| CaO | 0.6 |
| SrO | 0.1 |
| ZnO | 0.1 |
| ZrO₂ | 3.6. |

With this composition, the following properties are obtained:

| | |
|---|---|
| α₍₂₀₋₃₀₀₎ | 8.5 · 10⁻⁶/K; |
| T_{g} | 505° C.; and |
| Density | 2.5 g/cm³. |

### EXEMPLARY EMBODIMENT 10

Yet another composition of an inorganic, silicon-containing, in particular silicate, substantially fluid-free material is furthermore given, by way of example, by the following composition, in wt %:

| | |
|---|---|
| SiO₂ | 52 |
| Al₂O₃ | 17 |
| Na₂O | 12 |
| K₂O | 4 |
| MgO | 4 |
| CaO | 6 |
| ZnO | 3.5 |
| ZrO₂ | 1.5. |

With this composition, the following properties are obtained:

| | |
|---|---|
| α₍₂₀₋₃₀₀₎ | 9.7 · 10⁻⁶/K; |
| T_{g} | 556° C.; and |
| Density | 2.6 g/cm³. |

### EXEMPLARY EMBODIMENT 11

Yet another composition of an inorganic, silicon-containing, in particular silicate, substantially fluid-free material is furthermore given, by way of example, by the following composition, in wt %:

| | |
|---|---|
| SiO₂ | 62 |
| Al₂O₃ | 17 |
| Na₂O | 13 |
| K₂O | 3.5 |
| MgO | 3.5 |
| CaO | 0.3 |
| SnO₂ | 0.1 |
| TiO₂ | 0.6. |

With this composition, the following properties are obtained:

| | |
|---|---|
| α₍₂₀₋₃₀₀₎ | 8.3 · 10⁻⁶/K; |
| T_{g} | 623° C.; and |
| Density | 2.4 g/cm³. |

### EXEMPLARY EMBODIMENT 12

Yet another composition of an inorganic, silicon-containing, in particular silicate, substantially fluid-free material is furthermore given, by way of example, by the following composition, in wt %:

| | |
|---|---|
| SiO₂ | 61.1 |
| Al₂O₃ | 19.6 |
| B₂O₃ | 4.5 |
| Na₂O | 12.1 |
| K₂O | 0.9 |
| MgO | 1.2 |
| CaO | 0.1 |
| SnO₂ | 0.2 |
| CeO₂ | 0.3. |

With this composition, the following properties are obtained:

| | |
|---|---|
| α₍₂₀₋₃₀₀₎ | 8.9 · 10⁻⁶/K; |
| T_{g} | 600° C.; and |
| Density | 2.4 g/cm³. |

### EXEMPLARY EMBODIMENT 13

Yet another composition of an inorganic, silicon-containing, in particular silicate, substantially fluid-free material is furthermore given, by way of example, by the following composition, in wt %:

| | |
|---|---|
| SiO₂ | 50 to 65 |
| Al₂O₃ | 15 to 20 |
| B₂O₃ | 0 to 6 |
| Li₂O | 0 to 6 |
| Na₂O | 8 to 15 |
| K₂O | 0 to 5 |
| MgO | 0 to 5 |
| CaO | 0 to 7, preferably 0 to 1 |
| ZnO | 0 to 4, preferably 0 to 1 |
| ZrO₂ | 0 to 4 |
| TiO₂ | 0 to 1, preferably substantially free of TiO₂. |

Furthermore, the glass may include: from 0 to 1 wt %: P₂O₅, SrO, BaO; and from 0 to 1 wt % of refining agents: SnO₂, CeO₂, or As₂O₃, or other refining agents.

### EXEMPLARY EMBODIMENT 14

Yet another composition of an inorganic, silicon-containing, in particular silicate, substantially fluid-free material is furthermore given, by way of example, by the following composition, in wt %:

| | |
|---|---|
| SiO₂ | 58 to 65 |
| B₂O₃ | 6 to 10.5 |
| Al₂O₃ | 14 to 25 |
| MgO | 0 to 5 |
| CaO | 0 to 9 |
| BaO | 0 to 8 |
| SrO | 0 to 8 |
| ZnO | 0 to 2. |

### EXEMPLARY EMBODIMENT 15

Yet another composition of an inorganic, silicon-containing, in particular silicate, substantially fluid-free material is furthermore given, by way of example, by the following composition, in wt %:

| | |
|---|---|
| SiO₂ | 59.7 |
| Al₂O₃ | 17.1 |
| B₂O₃ | 7.8 |
| MgO | 3.4 |
| CaO | 4.2 |
| SrO | 7.7 |
| BaO | 0.1. |

2133.333USX

With this composition, the following properties are obtained:

| | |
|---|---|
| α₍₂₀₋₃₀₀₎ | 3.8 · 10⁻⁶/K; |
| T_{g} | 719° C.; and |
| Density | 2.51 g/cm³. |

### EXEMPLARY EMBODIMENT 16:

Yet another composition of an inorganic, silicon-containing, in particular silicate, substantially fluid-free material is furthermore given, by way of example, by the following composition, in wt %:

| | |
|---|---|
| SiO₂ | 59.6 |
| Al₂O₃ | 15.1 |
| B₂O₃ | 9.7 |
| CaO | 5.4 |
| SrO | 6.0 |
| BaO | 2.3 |
| ZnO | 0.5 |
| Sb₂O₃ | 0.4 |
| As₂O₃ | 0.7. |

With this composition, the following properties are obtained:

| | |
|---|---|
| α₍₂₀₋₃₀₀₎ | 3.8 · 10⁻⁶/K; and |
| Density | 2.5 g/cm³. |

### EXEMPLARY EMBODIMENT 17

Yet another composition of an inorganic, silicon-containing, in particular silicate, substantially fluid-free material is furthermore given, by way of example, by the following composition, in wt %:

| | |
|---|---|
| SiO₂ | 58.8 |
| Al₂O₃ | 14.6 |
| B₂O₃ | 10.3 |
| MgO | 1.2 |
| CaO | 4.7 |
| SrO | 3.8 |
| BaO | 5.7 |
| Sb₂O₃ | 0.2 |
| As₂O₃ | 0.7. |

With this composition, the following properties are obtained:

| | |
|---|---|
| α₍₂₀₋₃₀₀₎ | 3.73 · 10⁻⁶/K; |
| T_{g} | 705° C.; and |
| Density | 2.49 g/cm³. |

### EXEMPLARY EMBODIMENT 18

Yet another composition of an inorganic, silicon-containing, in particular silicate, substantially fluid-free material is furthermore given, by way of example, by the following composition, in wt %:

| | |
|---|---|
| SiO₂ | 62.5 |
| B₂O₃ | 10.3 |
| Al₂O₃ | 17.5 |
| MgO | 1.4 |
| CaO | 7.6 |
| SrO | 0.7. |

With this composition, the following properties are obtained:

| | |
|---|---|
| α₍₂₀₋₃₀₀₎ | 3.2 ppm/K; and |
| Density: | 2.38 g/cm³. |

### EXEMPLARY EMBODIMENT 19

Yet another composition of an inorganic, silicon-containing, in particular silicate, substantially fluid-free material is furthermore given, by way of example, by the following composition, in wt %:

| | |
|---|---|
| SiO₂ | 55 to 75 |
| Na₂O | 0 to 15 |
| K₂O | 0 to 14 |
| Al₂O₃ | 0 to 15 |
| MgO | 0 to 4 |
| CaO | 3 to 12 |
| BaO | 0 to 15 |
| ZnO | 0 to 5. |

### EXEMPLARY EMBODIMENT 20

Yet another composition of an inorganic, silicon-containing, in particular silicate, substantially fluid-free material is furthermore given, by way of example, by the following composition, in wt %:

| | |
|---|---|
| SiO₂ | 74.3 |
| Na₂O | 13.2 |
| K₂O | 0.3 |
| Al₂O₃ | 1.3 |
| MgO | 0.2 |
| CaO | 10.7. |

With this composition, the following properties are obtained:

| | |
|---|---|
| α₍₂₀₋₃₀₀₎ | 9.0 ppm/K; and |
| T_{g}: | 573° C. |

### EXEMPLARY EMBODIMENT 21

Yet another composition of an inorganic, silicon-containing, in particular silicate, substantially fluid-free material is furthermore given, by way of example, by the following composition, in wt %:

| | |
|---|---|
| SiO₂ | 72.8 |
| Na₂O | 13.9 |
| K₂O | 0.1 |
| Al₂O₃ | 0.2 |
| MgO | 4.0 |
| CaO | 9.0. |

With this composition, the following properties are obtained:

| | |
|---|---|
| α₍₂₀₋₃₀₀₎ | 9.5 ppm/K; and |
| T_{g}: | 564° C. |

### EXEMPLARY EMBODIMENT 22

Yet another composition of an inorganic, silicon-containing, in particular silicate, substantially fluid-free material is furthermore given, by way of example, by the following composition, in wt %:

| | |
|---|---|
| SiO₂ | 60.7 |
| Al₂O₃ | 16.9 |
| Na₂O | 12.2 |
| K₂O | 4.1 |
| MgO | 3.9 |
| ZrO₂ | 1.5 |
| SnO₂ | 0.4 |
| CeO₂ | 0.3. |

### EXEMPLARY EMBODIMENT 23

Another composition of an inorganic, silicon-containing, in particular silicate, substantially fluid-free material is furthermore given, by way of example, by the following composition, in wt %:

| | |
|---|---|
| SiO₂ | 84.1 |
| B₂O₃ | 11.0 |
| R₂O | 3.3 |
| Al₂O₃ | 0.5, |

wherein R₂O is the total of the alkali ions present in the material and furthermore preferably comprises Na₂O, Li₂O, and K₂O.

Unless not already listed, all the exemplary embodiments mentioned above may optionally contain refining agents from 0 to 1 wt %, for example SnO₂, CeO₂, As₂O₃, Cl⁻, F⁻, sulfates.

It is furthermore possible that the inorganic, silicon-containing, in particular silicate, substantially fluid-free material was subjected to a particular treatment which increases the strength of the material. If the material is a glass, such a treatment in particular includes tempering, for example thermal and/or chemical tempering, in particular chemical tempering.

In this case, chemical tempering of a glass is achieved by an ion exchange in an exchange bath. If a tempered glass is used it is distinguished, prior to the application of functional layers of an electrical storage system, by exhibiting a chemical prestress which is characterized by a thickness of the ion-exchanged layer L_{DoL} of at least 10 μm, preferably at least 15 μm, and most preferably at least 25 μm, and by a compressive stress at the surface of the glass, σ_{CS}, of preferably at least 100 MPa, more preferably at least 200 MPa, yet more preferably at least 300 MPa, and most preferably 480 MPa or more.

During the application and post treatment of functional layers of an electrical storage system, the glass that is used as a substrate may experience a processing related alteration in its stress state. Surprisingly, it has been found that in this case the prestress of the glass is not reduced to zero, but rather a residual stress is retained in the glass so that overall the strength of the glass used as a substrate will be enhanced compared to a conventional non-tempered glass.

The glass that is provided in form of the substrate in the finished energy storage may be distinguished by constituting an at least partially chemically tempered glass, and the at least partial chemical prestress is obtained by an ion exchange in an exchange bath and a subsequent exposure to a thermal load and is characterized by a thickness of the ion-exchanged layer (L_{DoL}) of at least 10 μm, preferably at least 15 μm, and most preferably at least 25 μm, and by a compressive stress (σ_{CS}) at the surface of the glass of at least 100 MPa, preferably at least 200 MPa, more preferably at least 300 MPa, and most preferably 480 MPa or more, wherein the thickness of the ion-exchanged layer prior to the exposure to the thermal load is smaller than the thickness of the ion-exchanged layer after the exposure to the thermal load, and wherein the compressive stress at the surface of the glass prior to the exposure to the thermal load is greater than the compressive stress at the surface of the glass after the exposure to the thermal load.

In one embodiment of the invention, the chemical tempering of the glass is achieved in an exchange bath which includes lithium ions, such as, e.g., an exchange bath including different alkali ions such as potassium and low or lowest fractions of lithium. Also, a multi-stage process may be performed, for example exchange with potassium and a further rapid exchange using a lithium-containing bath.

Furthermore, unless an Li₂O content is already included in the composition, it is possible to modify the listed exemplary embodiments in such a way that they contain a significant content of Li₂O exceeding the fraction of unavoidable traces. Such a fraction will be given starting from a Li₂O content of greater than or equal to 0.1 wt %.

The modification with the composition of the sheet-like element may be obtained in such a way that any other included alkali metal oxides are proportionately reduced in the composition of the sheet-like element, so that the content of the remaining components relative to the alkali metal oxides remains the same, or the Li₂O is added in addition to the other components so that the proportion of the latter is correspondingly reduced.

If Li₂O is contained in a sheet-like element, its proportion is at least 0.1 wt % and is furthermore less than 7.0 wt %, preferably less than 5.2 wt %, more preferably less than 2.5 wt %, yet more preferably less than 0.5 wt %, and most preferably less than 0.2 wt %.

### DESCRIPTION OF THE DRAWINGS

FIG. 1 schematically illustrates a thin film battery according to the invention;

FIG. 2 schematically illustrates a further thin film battery according to the invention; and

FIG. 3 schematically illustrates a sheet-like configuration of an inorganic, silicon-containing, in particular silicate, substantially fluid-free material according to the invention.

### DETAILED DESCRIPTION

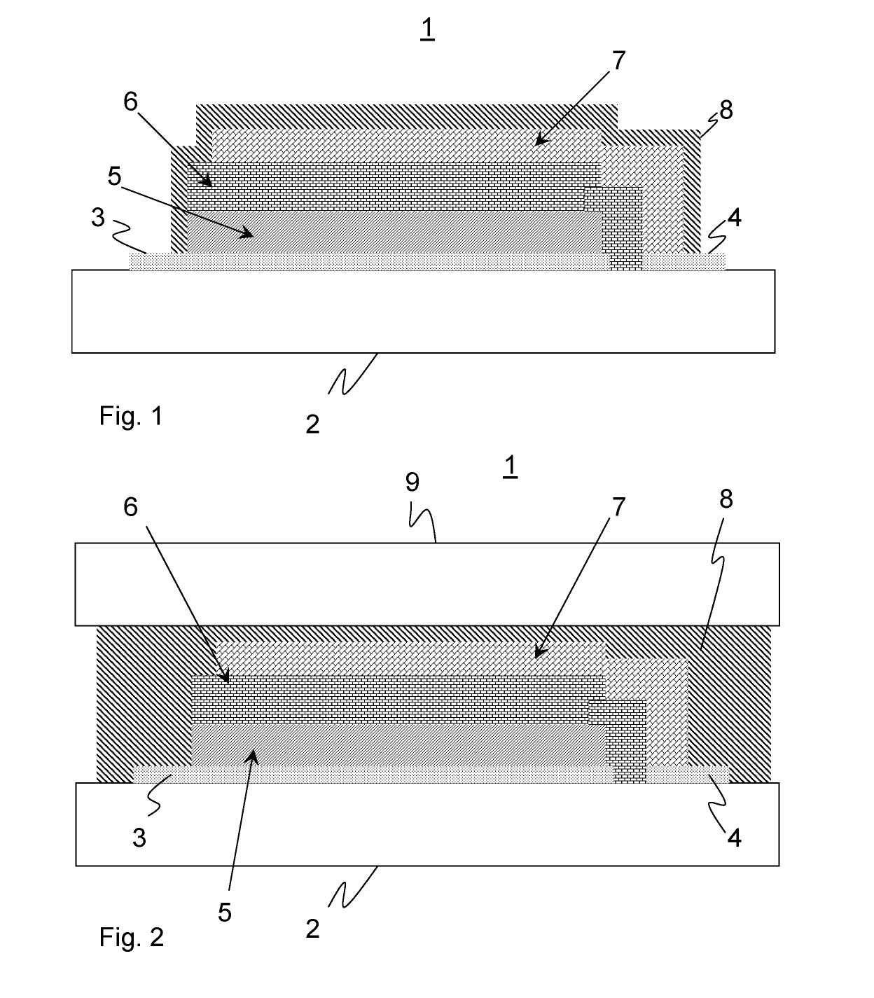

FIG. 1 schematically shows a thin film battery 1 according to the present invention. It comprises a substrate 2 which is made of an inorganic, silicon-containing, in particular silicate, substantially fluid-free material. On the substrate, a sequence of different layers is applied. By way of example and without being limited to the present example, first the two collector layers are applied on the substrate 2, cathode collector layer 3, and anode collector layer 4. Such collector layers usually have a thickness of a few micrometers and are made of a metal, for example of copper, platinum, aluminum, or titanium. Superimposed on collector layer 3 is cathode layer 5. If the thin film battery 1 is a lithium-based thin film battery, the cathode is made of a lithium-transition metal compound, preferably an oxide, for example of LiCoO₂, LiMnO₂, or else LiFePO₄. Furthermore, the electrolyte 6 is applied on the substrate and is at least partially overlapping cathode layer 5. In the case of a lithium-based thin film battery, this electrolyte is mostly LiPON, a compound of lithium with oxygen, phosphorus, and nitrogen. Furthermore, the battery 1 comprises an anode 7 which may for instance be made of lithium titanium oxide or else of metallic lithium. Anode layer 7 is at least partially overlapping electrolyte layer 6 and collector layer 4. Furthermore, battery 1 comprises an encapsulation layer 8.

At least the substrate 2 is made of an inorganic, silicon-containing, in particular silicate, substantially fluid-free material, wherein for the purposes of the present invention a material is referred to as substantially fluid-free if it includes less than 2 wt %, preferably less than 0.5 wt %, and most preferably less than 0.2 wt % of fluids. The encapsulation layer 8 may as well be made of an inorganic, silicon-containing, in particular silicate, substantially fluid-free material.

In the context of the present invention, any material which prevents or at least greatly reduces the attack of fluids or other corrosive materials on the battery 1 is considered as an encapsulation or sealing of the thin film battery 1. Such encapsulation is distinguished by the fact that it seals at least partially at least one boundary surface of at least one functional layer of the thin film battery, for example by covering the material.

FIG. 2 illustrates a further embodiment of a thin film battery 1 according to the invention. In this case, the configuration of the thin film battery 1 substantially corresponds to that of the thin film battery of FIG. 1, but the encapsulation is formed differently. Here, the encapsulation layer 8 is formed so as to enclose the entire layer structure of thin film battery 1. Additionally, a superstrate 9 is arranged on encapsulation layer 8, which may, for example, also be made of the inorganic, silicon-containing, in particular silicate, substantially fluid-free material of the present invention. If the encapsulation layer 8 is made of an organic or semi-organic material, the superstrate provides an additional permeation barrier against fluids.

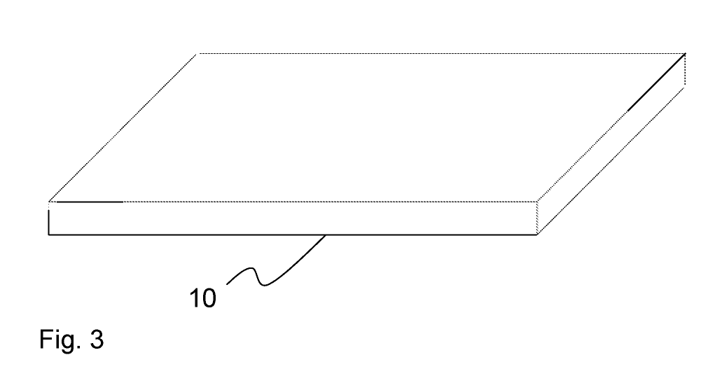

FIG. 3 schematically illustrates the inorganic, silicon-containing, in particular silicate, substantially fluid-free material of the present invention, here in the form of a sheet-like shaped body. In the context of the present invention, a shaped body is referred to as being sheet-like or a sheet if its dimension in one spatial direction is not more than half of that in the two other spatial directions. A shaped body is referred to as a ribbon in the present invention if it has a length, width, and thickness for which the following relationship applies: the length is at least ten times larger than the width which in turn is at least twice as large as the thickness.

### LIST OF REFERENCE NUMERALS

1 Thin film battery

### 2 Substrate

3 Cathode collector layer
4 Anode collector layer

### 5 Cathode

### 6 Electrolyte

### 7 Anode

8 Encapsulation layer

### 9 Superstrate

10 Sheet-like shaped body

What is claimed is:

1. A thin film battery, comprising:
a service life, wherein the service life is a feature selected from the group consisting of:
a cycle stability of at least 5,000 cycles, one cycle comprising one discharging and one charging process of the thin film battery, and cycle stability being the number of cycles that can at least be performed without causing failure of the thin film battery, wherein the failure is defined as electrical energy no longer being capable of being stored in or drawn from the battery,
a storage stability under normal atmosphere of at least one year without causing failure of the thin film battery,
a continuous operation durability of at least 5,000 hours, the continuous operation durability being the time during which electrical energy is actively drawn from or supplied to the battery, and
combinations thereof;
a fluid content of 2000 ppm or less based on a weight of the thin film battery, wherein the fluid content refers to liquid and/or gaseous substances and their chemical and physical adsorbates and/or their derivatives, wherein the fluids comprise H₂O, O₂, N₂, CO₂, and hydrogen halides and their chemical and physical adsorbates and non-volatile lithium compounds; and
at least one element made of an inorganic, silicon-containing, material that has an H₂O content of less than 2 wt %, wherein fluid substances that are bound within a chemical structure of the inorganic, silicon-containing, material are included in the H₂O content.

2. The thin film battery as claimed in claim 1, wherein the fluid substances are selected from the group consisting of crystallization water, hydrates, OH groups, and combinations thereof.

3. The thin film battery as claimed in claim 1, wherein the H₂O content is less than 0.05 wt %.

4. The thin film battery as claimed in claim 1, further comprising at least one encapsulation, wherein the encapsulation at least partially seals at least one boundary surface of at least one functional layer of the thin film battery.

5. The thin film battery as claimed in claim 4, wherein the at least one encapsulation is at least partially made of the inorganic, silicon-containing material.

6. The thin film battery as claimed in 4, wherein the at least one encapsulation is at least partially made of an organic and/or semi-organic material.

7. The thin film battery as claimed in claim 4, wherein the inorganic, silicon-containing, material has a specific electrical resistance at a temperature of 350° C. and at an alternating current with a frequency of 50 Hz of greater than 1.0*10⁶ Ohm·cm.

8. The thin film battery as claimed in claim 1, wherein the inorganic, silicon-containing, material exhibits a maximum load temperature θ_{Max} of at least 300° C.

9. The thin film battery as claimed in claim 1, wherein the inorganic, silicon-containing, material has a coefficient of linear thermal expansion in a range from 2.0*10⁻⁶/K to 10*10⁻⁶/K.

10. The thin film battery as claimed in claim 1, wherein the inorganic, silicon-containing, material comprises network formers and separation site formers, and wherein the inorganic, silicon-containing, material has a molar ratio of separation site formers to network formers of less than or equal to 0.25.

11. The thin film battery as claimed in claim 1, wherein the inorganic, silicon-containing, material is isotropic or amorphous.

12. The thin film battery as claimed in claim 11, wherein the inorganic, silicon-containing, material is a glass.

13. The thin film battery as claimed in claim 11, wherein the inorganic, silicon-containing, material is a substrate and/or a superstrate.

14. The thin film battery as claimed in claim 11, wherein the inorganic, silicon-containing, material is a ribbon or sheet.

15. The thin film battery as claimed in claim 1, further comprising a getter for fluids.

16. The thin film battery as claimed in claim 15, wherein the getter comprises a reaction and/or sacrificial material that forms insoluble or only poorly soluble compounds with fluids.

17. The thin film battery as claimed in claim 15, wherein the getter is a metal selected from the group consisting of a base metal, an alkali metal, an alkaline earth metal, a mixture or alloy of metals, an alkali metal and/or alkaline earth metal mixture, an alkali metal and/or alkaline earth metal alloy, an adsorbent, and combinations thereof.

18. An inorganic, silicon-containing, material, comprising:
an H₂O content of less than 2 wt %, wherein fluid substances which are bound within a chemical structure of the material are included in the H₂O content;
a network of vertex-linked structural components formed of oxygen coordination polyhedra of network forming elements;
separation site formers; and
a molar ratio of separation site forming elements to network forming elements of less than or equal to 0.25.

19. The inorganic, silicon-containing, material as claimed in claim 18, wherein the H₂O content is less than 0.05 wt %.

20. The inorganic, silicon-containing, material as claimed in claim 18, wherein the vertex-linked structural components comprise a network of vertex-linked tetrahedra of general formula [XO₄], where X comprises at least silicon and/or aluminum.

21. The inorganic, silicon-containing, material as claimed in claim 18, wherein the molar ratio is between 0.015 and 0.16.

22. The inorganic, silicon-containing, material as claimed in claim 18, wherein the material is isotropic.

23. The inorganic, silicon-containing, material as claimed in claim 18, wherein the material has an inner structure configured as a three-dimensionally linked dense network exhibiting substantially random linking, without far order, of the coordination polyhedra forming the material.

24. The inorganic, silicon-containing, material as claimed in claim 18, further comprising an Li₂O content of between at least 0.1 wt % and 7 wt %.

25. The inorganic, silicon-containing, material as claimed in claim 24, wherein the Li₂O content varies across a cross section of the material.

26. The inorganic, silicon-containing, material as claimed in claim 18, further comprising a permeation rate for fluids of <10⁻³ g/(m²·d).

27. The inorganic, fluid-free, material as claimed in claim 18, further comprising a property selected from the group consisting of a maximum load temperature θ_{Max} of at least 300° C., a specific electrical resistance at a temperature of 350° C. and at an alternating current with a frequency of 50 Hz of greater than greater than 1.0*10⁶ Ohm·cm, a coefficient of linear thermal expansion a in a range from 2.0*10⁻⁶/K to 10*10⁻⁶/K, and combinations thereof.

28. The inorganic, silicon-containing, material as claimed in claim 18, wherein the material is a sheet-like shaped body or a layer.

29. The inorganic, silicon-containing, material as claimed in claim 18, further comprising a thickness of less than 2 mm.

30. The inorganic, silicon-containing, material as claimed in claim 18, wherein the material is in the form of a layer.

31. The inorganic, silicon-containing, material as claimed in claim 30, wherein the layer is a vapor deposition layer or an electron beam evaporation layer.

32. A method for producing a thin film battery, comprising the steps of:
providing a substrate in the form of a sheet-like shaped body, the substrate being made of an inorganic, silicon-containing, material that has an H₂O content of less than 2 wt %, wherein fluid substances that are bound within a chemical structure of the inorganic, silicon-containing, material are included in the H₂O content;
applying a functional layer to the substrate;
subjecting the substrate and functional layer to a heat treatment to achieve the H₂O content at a temperature below 500° C.; and
applying an encapsulation to the functional layer, the encapsulation at least partially sealing at least one boundary surface of the functional layer.

33. The method as claimed in claim 31, further comprising applying a getter material for fluids onto the substrate.

34. The method as claimed in claim 33, wherein the getter material is applied before performing the prior to subjecting the substrate to the heat treatment, and wherein the getter material is removed after subjecting the substrate to the heat treatment.
